(19) United States
(12) Patent Application Publication
(10) Pub. No.: US 2012/0023967 A1
(43) Pub. Date: Feb. 2, 2012

(54) AUXILIARY POWER UNIT WITH HOT SECTION FIRE ENCLOSURE ARRANGEMENT

(76) Inventors: Brian C. DeDe, San Diego, CA (US); David Lau, San Diego, CA (US); Thomas Wayne Minor, Del Mar, CA (US)

(21) Appl. No.: 12/847,131

(22) Filed: Jul. 30, 2010

(51) Int. Cl. F02C 7/20

(52) U.S. Cl. 60/796

(57) ABSTRACT

A Hot Section Fire Enclosure for a gas turbine engine according to an exemplary aspect of the present disclosure includes a multiple of supports mounted between a Hot Section Fire Enclosure support ring and a shroud, at least one of the supports includes a hollow support pin which spaces the Hot Section Fire Enclosure support ring relative the shroud.

### STATEMENT REGARDING FEDERALLY SPONSORED RESEARCH OR DEVELOPMENT

This invention was made with government support under Contract No. N00019-06-C-0081 awarded by the United States Navy. The Government has certain rights in this invention.

### BACKGROUND

The present disclosure relates to an auxiliary power unit (APU), and more particularly to a hot section fire enclosure arrangement therefore.

Many aircraft are equipped with an APU to provide electrical and pneumatic power for such tasks as environmental control, lighting, powering electronics, main engine starting, etc.

For aircraft APU installations, a dedicated fire zone is typically defined within the aircraft. Alternatively, some APUs include a Hot Section Fire Enclosure (HSFE) within which is a fire zone. Although effective, the HSFE may complicate access to line replaceable units (LRUs).

### SUMMARY

A HSFE for a gas turbine engine according to an exemplary aspect of the present disclosure includes a multiple of supports mounted between a HSFE support ring and a shroud, at least one of the supports includes a hollow support pin which spaces the HSFE support ring relative the shroud.

A gas turbine engine according to an exemplary aspect of the present disclosure includes a HSFE access cover mountable to the HSFE. A first and second fireproof split ring section. A split ring retainer mountable to the HSFE access cover to retain the first and second fireproof split ring sections to sandwich a LRU component therein.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a partial phantom view of a rotary-wing aircraft illustrating a power plant system;

FIG. 2 is a general perspective view of an APU hot section;

FIG. 3 is a general perspective view of a gas turbine engine APU installed within an airframe of the exemplary rotary wing aircraft embodiment;

FIG. 4 is a longitudinal sectional view of an APU hot section;

FIG. 5 is a lateral sectional view of an APU hot section;

FIG. 6 is a lateral sectional view of a support for a HSFE for the APU hot section;

FIG. 7 is an exploded lateral sectional view of the support;

FIG. 8 is a perspective view of a support for a HSFE with a HSFE access cover for access to a LRU; and

FIG. 9 is a sectional view of the HSFE access cover.

### DETAILED DESCRIPTION

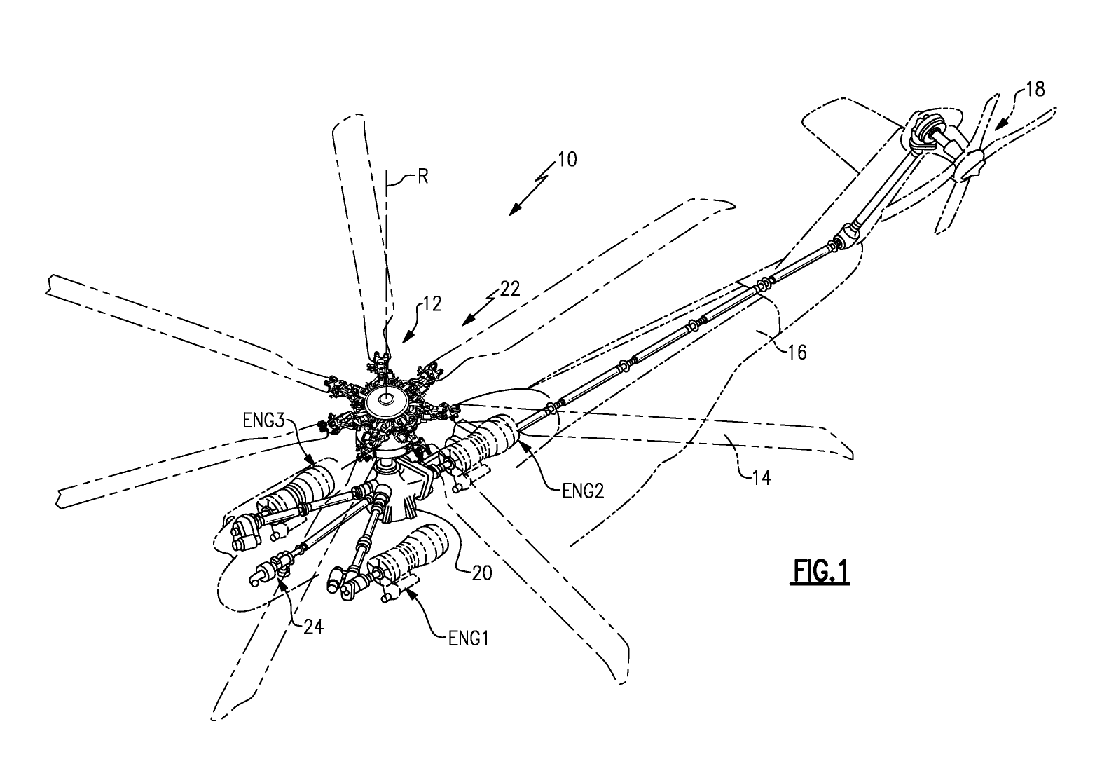

FIG. 1 schematically illustrates a rotary-wing aircraft 10 having a main rotor system 12. The aircraft 10 includes an airframe 14 having an extending tail 16 which mounts an anti-torque system 18. The main rotor system 12 is driven about an axis of rotation A through a main rotor gearbox (MGB) 20 by a multi-engine powerplant system 22—here having three engine packages ENG1, ENG2, ENG3 as well as an Auxiliary Power Unit (APU) 24. The engine packages ENG1, ENG2, ENG3 and APU 24 are examples of gas turbine engines. The multi-engine powerplant system 22 generates the power available for flight operations and couples such power to the main rotor system 12 through the MGB 20. Although a particular helicopter configuration is utilized to disclose the APU 24, it should be further understood that various vehicles and systems such as ground carts, commercial airplanes and helicopters, military airplanes, LCAC landing craft, tanks etc., will also benefit herefrom.

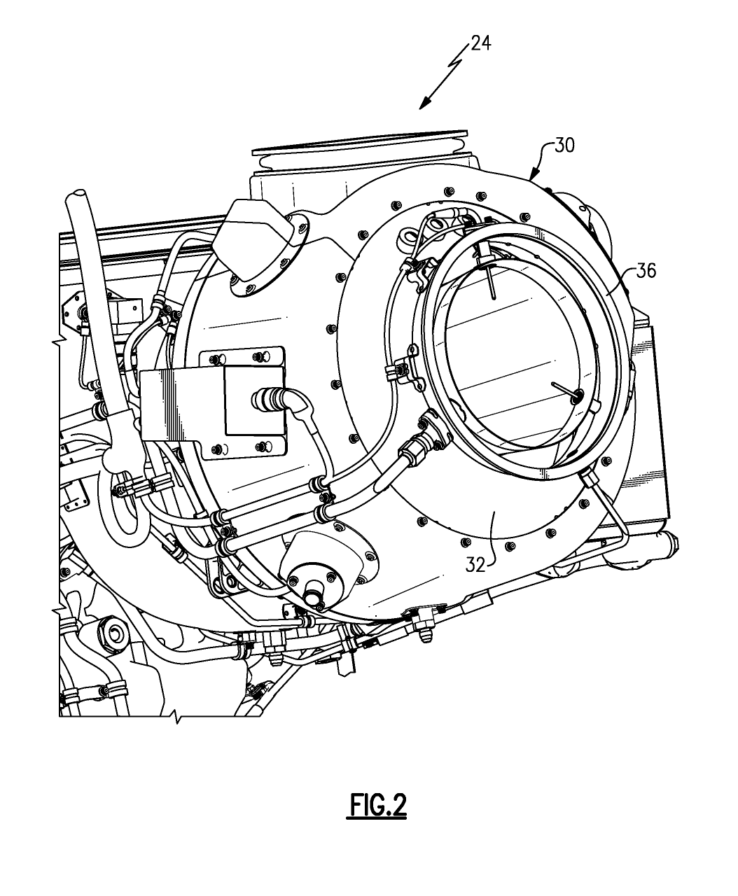

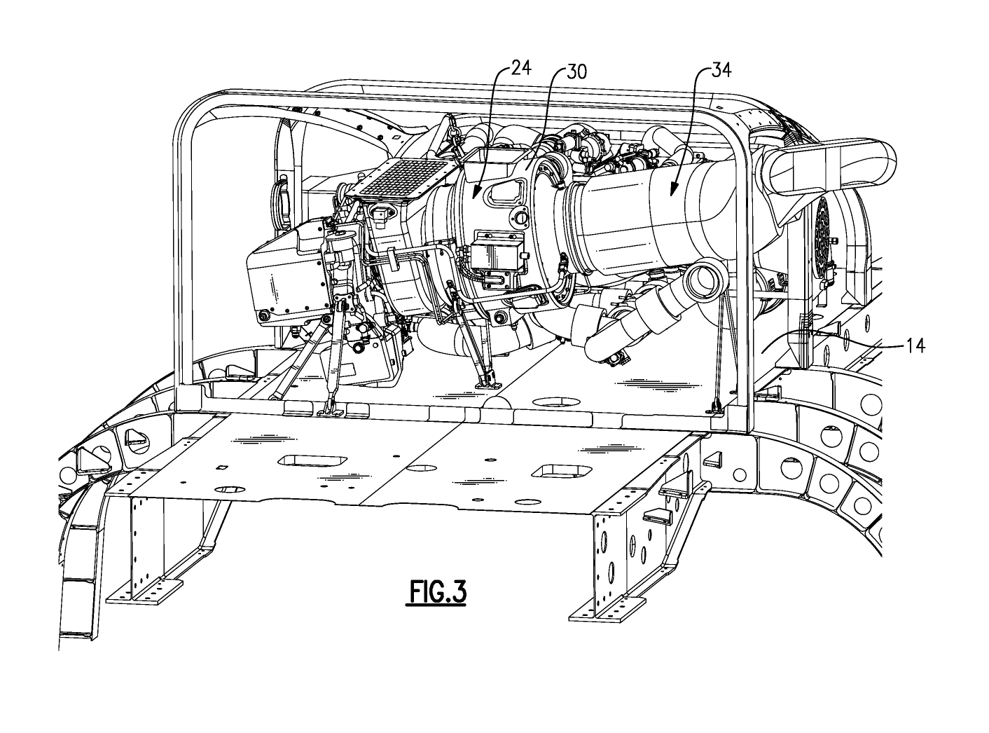

Referring to FIG. 2, the APU 24 includes a Hot Section Fire Enclosure (HSFE) 30 with a HSFE aft support ring 32 to support a downstream exhaust system 34 (FIG. 3) through a flange 36. The HSFE 30 may be defined by a multiple of components disposed around the APU 24. Gaskets (not illustrated) may be used between the constituent components of any respective joint (not illustrated); alternatively, the pitch of the bolt pattern which attach the constituent components can be designed to form a fireproof joint.

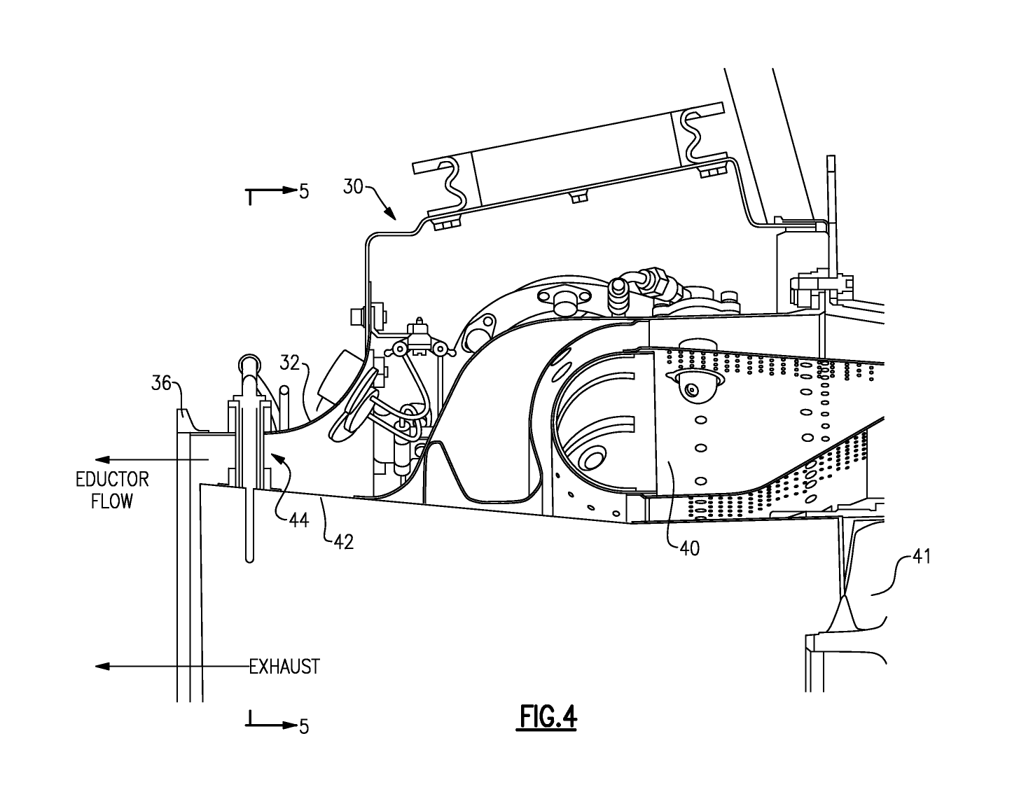

With reference to FIG. 4, the HSFE 30 defines a fire zone to at least partially enclose a combustor section 40 and an exhaust shroud 42 which are generally downstream of a turbine wheel 41. It should be understood that various HSFE arrangements may alternatively or additionally be utilized.

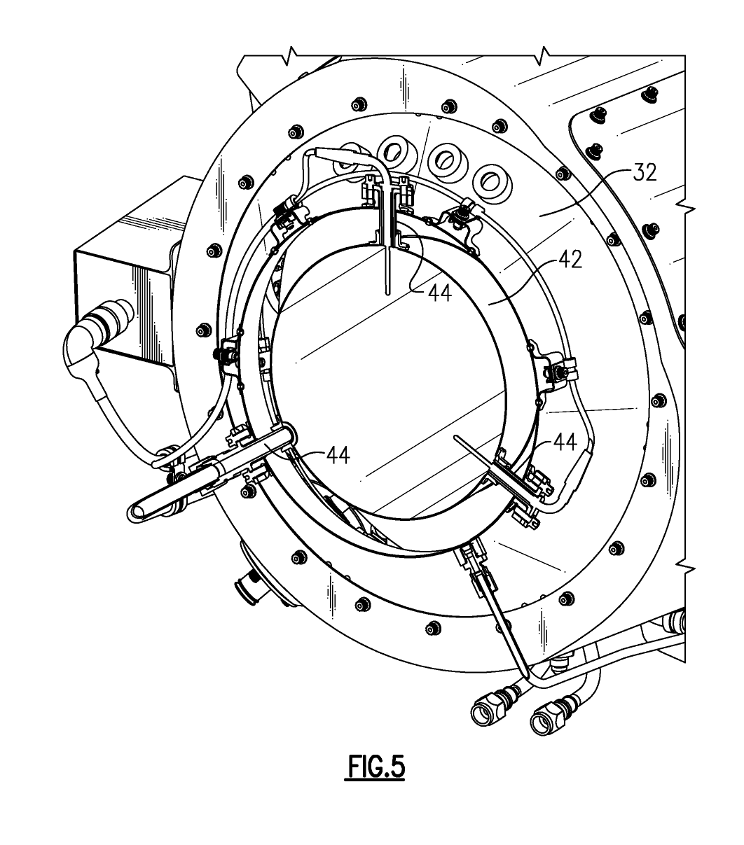

The aft support ring 32 defines an annular eductor flow around an exhaust flow from the exhaust shroud 42. The HSFE aft support ring 32 is spaced relative the exhaust shroud 42 through a multiple of supports 44 (also illustrated in FIG. 5). It should be understood that any number of supports 44 may be utilized.

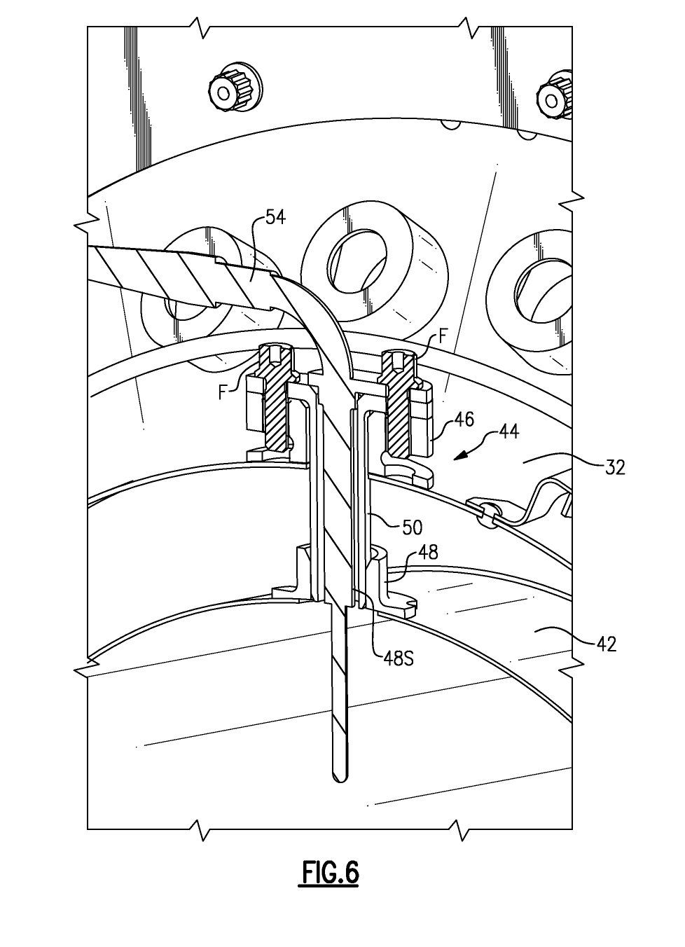

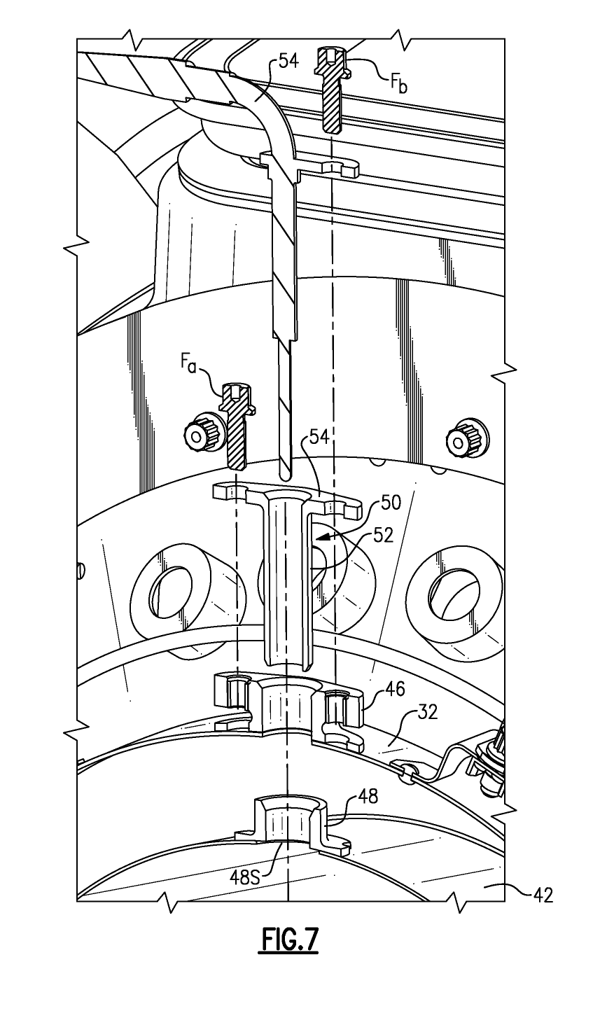

With reference to FIG. 6, each support 44 generally includes a mounting boss 46 brazed to the HSFE aft support ring 32, a sleeve 48 brazed to the exhaust shroud 42, a hollow support pin 50 and at least one fastener F. The hollow support pin 50 may include a hollow pin member 52 with a transverse flange 52F to form a “T” shape (FIG. 7). The flange 52F receives the fasteners F to bolt the hollow support pin 50 to the HSFE aft support ring 32. The hollow pin member 52 fits within and abuts a contact surface 48S within the sleeve 48. That is, the hollow support pin 50 supports the exhaust shroud 42 in a radial manner.

The hollow pin member 52 permits entry of a thermocouple 54 or others such line replaceable unit (LRU) to be mounted external to the HFSE aft support ring 32 thereby facilitating maintenance without the necessity of HFSE 30 disassembly. It should be understood that the hollow support pin 50 may be utilized for other purposes such as for a vent. One fastener Fa may be utilized to assemble the support 44 while the other fastener Fb may be utilized to assemble the support 44 and retain the thermocouple 54 (FIG. 7).

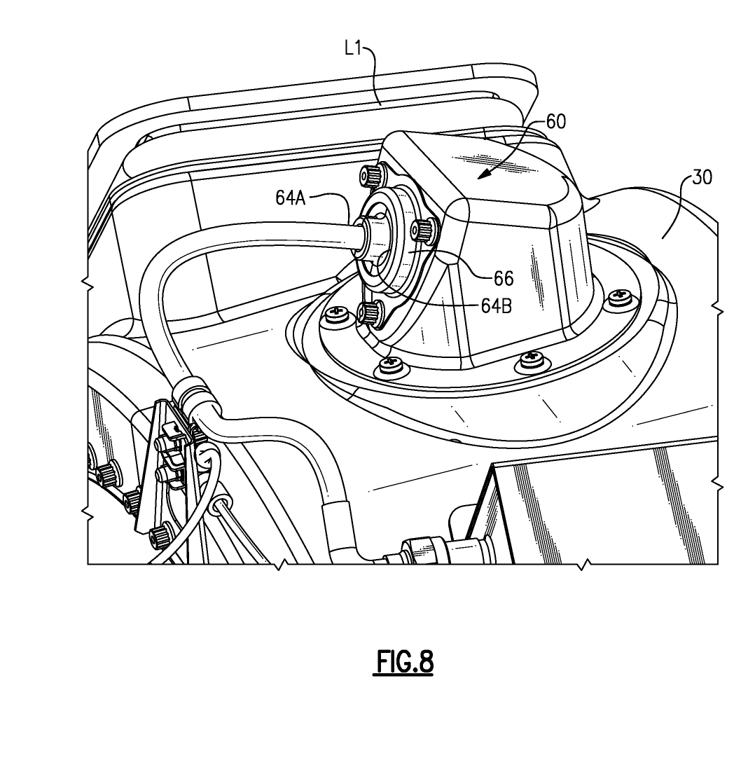

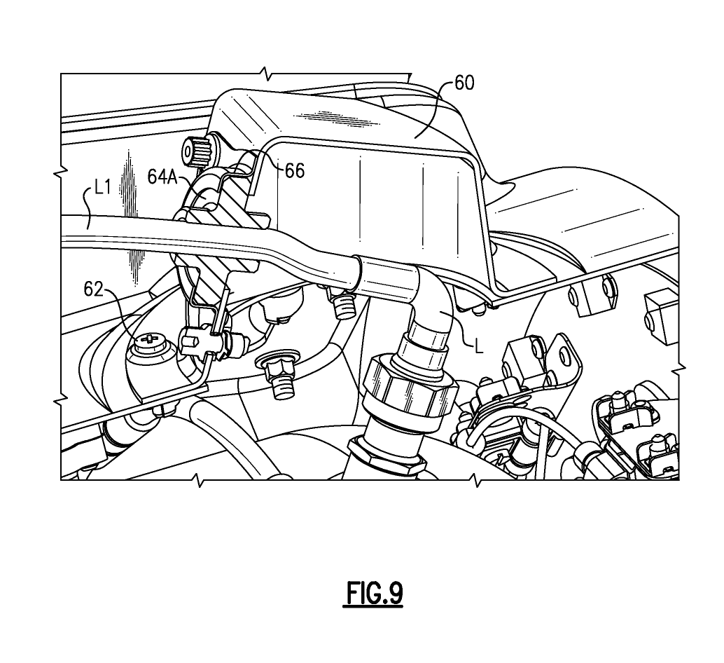

With reference to FIG. 8, the HSFE 30 may additionally include a HSFE access cover 60 which mounts to the HSFE 30 in a fireproof relationship. The HSFE access cover 60 is sized to mount a LRU such as an ignitor L or other component which has a conduit or access lead L1 connected thereto (FIG. 9). The HSFE access cover 60 facilitates removal and replacement of the LRU yet maintains a fire seal.

With reference to FIG. 9, the access cover 60 is fastened to the HSFE 30 with a multiple of fasteners 62. The lead L1 from the ignitor L is sandwiched between two fireproof split rings 64A, 64B. It should be understood that various other LRUs may alternatively benefit herefrom. The split rings 64A, 64B are sized so that any gaps provide a large enough length to gap ratio to prevent fire penetration. A split ring retainer 66 mounts the fireproof split rings 64A, 64B to the access cover 60 to retain the split rings 64A, 64B and sandwich the lead L1 therein. The access cover 60 and the split ring retainer 66 are sized to receive the ignitor L or other LRU to facilitate replacement without disassembly of the HSFE 30 from the APU 24.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A Hot Section Fire Enclosure for a gas turbine engine comprising:
a multiple of supports mounted between a Hot Section Fire Enclosure support ring and a shroud, at least one of said supports includes a hollow support pin which spaces said Hot Section Fire Enclosure support ring relative said shroud.

2. The Hot Section Fire Enclosure as recited in claim 1, wherein said shroud is an exhaust shroud.

3. The Hot Section Fire Enclosure as recited in claim 2, wherein said Hot Section Fire Enclosure support ring defines an eductor annulus around said exhaust shroud.

4. The Hot Section Fire Enclosure as recited in claim 1, further comprising a thermocouple which extends at least partially through said hollow support pin.

5. The Hot Section Fire Enclosure as recited in claim 1, wherein said hollow support pin includes a hollow pin member with a transverse flange.

6. The Hot Section Fire Enclosure as recited in claim 5, wherein said hollow pin member and said transverse flange forms a “T” shape.

7. The Hot Section Fire Enclosure as recited in claim 5, further comprising a mounting boss brazed to said Hot Section Fire Enclosure support ring.

8. The Hot Section Fire Enclosure as recited in claim 7, further comprising a sleeve brazed to said shroud, said hollow pin member spans said mounting boss and said sleeve to radially space said Hot Section Fire Enclosure support ring relative said shroud.

9. The Hot Section Fire Enclosure as recited in claim 8, further comprising a thermocouple which extends at least partially through said hollow support pin and into said shroud.

10. A gas turbine engine comprising:
a Hot Section Fire Enclosure;
a Hot Section Fire Enclosure access cover mountable to said a Hot Section Fire Enclosure;
a first fireproof split ring section;
a second fireproof split ring section matable with said first fireproof split ring section; and
a split ring retainer mountable to said Hot Section Fire Enclosure access cover to retain said first and second fireproof split ring sections to sandwich a Line Replaceable Unit component therein.

11. The gas turbine engine as recited in claim 10, wherein said Line Replaceable Unit component is an ignitor lead.

12. The gas turbine engine as recited in claim 10, wherein said first and second fireproof split ring sections are sized so that any gaps are of a large enough length to gap ratio to prevent fire penetration.

13. The gas turbine engine as recited in claim 10, further comprising a multiple of supports mounted between a Hot Section Fire Enclosure support ring mounted to said Hot Section Fire Enclosure and a shroud, at least one of said supports includes a hollow support pin which spaces said Hot Section Fire Enclosure support ring relative said shroud.

14. The gas turbine engine as recited in claim 13, further comprising a thermocouple which extends at least partially through said hollow support pin.
